(19) United States
(12) Patent Application Publication
(10) Pub. No.: US 2013/0333291 A1
(43) Pub. Date: Dec. 19, 2013

(54) ACTUATING DRIVE FOR MOVING A FURNITURE FLAP

(71) Applicant: Julius Blum GmbH, Hochst (AT)

(72) Inventor: Johannes BLUM, Hochst (AT)

(73) Assignee: Julius Blum GmbH, Hochst (AT)

(21) Appl. No.: 13/972,222

(22) Filed: Aug. 21, 2013

Related U.S. Application Data
(63) Continuation of application No. PCT/AT2011/000498, filed on Dec. 16, 2011.

(30) Foreign Application Priority Data
Feb. 22, 2011 (AT) A 233/2011

(51) Int. Cl. E05F 1/12; E06B 3/38

(52) U.S. Cl. CPC E05F 1/1253; E06B 3/385
USPC 49/386; 16/298

(57) ABSTRACT

The invention relates to an actuating drive for moving a flap of a piece of furniture, comprising: at least one pivotably supported actuating arm for moving the flap, a spring device for applying a pivoting torque to the actuating arm in the opening direction, and an adjusting device having an adjusting screw, which has a thread, wherein the pivoting torque of the spring device acting on the actuating arm can be adjusted by means of a rotational motion of the adjusting screw, wherein the adjusting screw has a screw shaft, wherein a screw nut is supported in such a way that said nut can be moved along the screw shaft by means of a rotational motion of the adjusting screw, wherein the adjusting screw has a blocking device separate from the thread, which blocking device prevents an unintentional rotational motion of the adjusting screw.

The present invention concerns an actuating drive for moving a flap of an article of furniture comprising:
at least one pivotably mounted actuating arm for moving the flap,
a spring device for acting on the actuating arm with a pivotal moment in the opening direction,
an adjusting device having an adjusting screw with a thread, wherein the acting pivotal moment of the spring device on the actuating arm is adjustable by a rotary movement of the adjusting screw,
wherein the adjusting screw has a screw shank, wherein a screw nut is mounted displaceably along the screw shank by a rotary movement of the adjusting screw.

The invention further concerns an arrangement with an actuating drive of the kind to be described and with a flap of an article of furniture which is mounted moveably by the actuating drive between a vertical closed position and an upwardly moved open position.

An actuating drive comprising an actuating arm, a spring device acting on the actuating arm for compensation of the weight of the flap and an adjusting device for adjusting the pivotal moment acting on the actuating arm is described for example in WO 2006/005086 A1 to the present applicant. That actuating drive includes a pivotably mounted intermediate lever which pivots the actuating arm by way of a pressure roller and an actuating contour, wherein the distance of the engagement point of the spring device relative to the axis of rotation of the intermediate lever is continuously adjustable by an adjusting device. For that purpose, the adjusting device can include a rotatably mounted threaded spindle, wherein the engagement point of the spring device relative to the threaded spindle is adjustable by rotation thereof within predetermined limits. Displacement of the spring engagement point along the threaded spindle however is effected relatively slowly because a considerable adjustment of the spring force requires correspondingly many revolutions of the threaded spindle. In addition, minor adjustments of the spring force can only be controlled with difficulty for the person performing the adjustment of the spring force, and are often scarcely perceptible.

DE 20 2005 015 002 U1 discloses a spring door band with a rotary axis portion which is pre-stressed by a spring element. The rotary axis portion is provided with a thread, wherein the pre-stressing of the spring element is variable and adjustable by screwing the rotary axis portion in and out relative to a hinge sleeve. The axial and radial position of the rotary axis portion can be locked by a setscrew.

It is an object of the present invention to propose an actuating drive of the general kind set forth in the opening part of this specification, wherein adjustment of the spring force is simplified.

According to the invention that is attained by the features as recited in claim 1. Further advantageous embodiments of the invention are recited in the appendant claims.

According to the invention, it is provided that the adjusting screw has a restraining device which is separate from the thread and which prevents an unintentional rotary movement of the adjusting screw.

A restraining device which is separate from the thread of the adjusting screw means that it is now also possible to use adjusting screws or threaded spindles which for the purposes of a large adjustment stroke also have a correspondingly high thread pitch gradient in comparison with a regular thread. Such threads with a high pitch gradient (with a double or multiple pitch gradient in comparison with a regular thread) also have however a slight self-locking action in relation to a regular thread, and for that reason according to the present invention there is provided a restraining device which admittedly allows controlled adjustment of the adjusting screw, but in contrast prevents unintentional displacement of the adjusting screw. Such uncontrolled displacement is frequently caused by a flap of an article of furniture which is connected to the actuating arm in the position of use being opened or closed a plurality of times, whereby the adjusting screw is unintentionally rotated. The restraining device provided can substantially prevent such uncontrolled displacement of the adjusting screw.

In an embodiment of the invention it can be provided that the restraining device is operative between the adjusting screw and a support means, which is preferably fixed with respect to the housing, of the actuating drive.

In that case the restraining device can include surface elements which are formed or arranged on the adjusting screw and which cooperate with the support means of the actuating drive. Those surface elements can be formed or arranged on a screw head, preferably at the underside and/or at a peripheral edge, of the adjusting screw. Possible variants are afforded by the surface elements being in the form of knobs, grooves, teeth, points, raised portions, recessed portions and/or in the form of a relief-like structure which interact with the support means provided on the actuating drive in force-locking relationship and/or at least partially in positively locking relationship.

In an alternative embodiment of the invention it can be provided that the screw head is subjected to a force by a mechanical spring element, thereby permitting controlled adjustment of the adjusting screw, whereas uncontrolled displacement of the screw is prevented by virtue of the spring force acting on the screw head.

The arrangement according to the invention has an actuating drive of the kind in question and a flap of an article of furniture, which is mounted moveably by the actuating drive between a vertical closed position and an upwardly moved open position.

Further details and advantages of the invention are described by means of the specific description hereinafter. In the drawing:

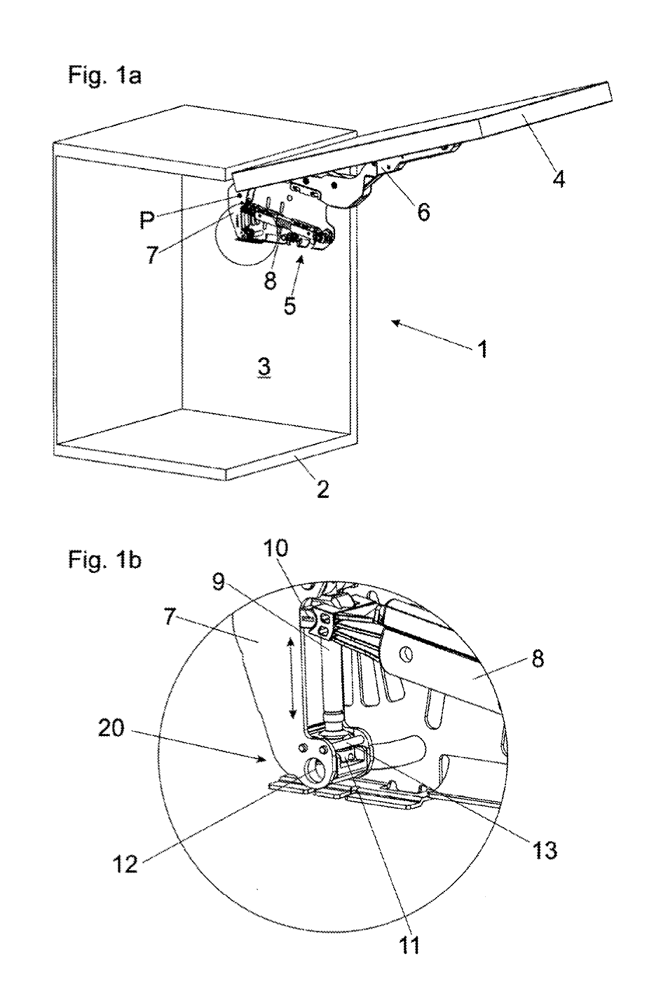

FIGS. 1a, 1b show a perspective view of an article of furniture with a flap which is movable upwardly relative thereto as well as an enlarged detail view thereof,

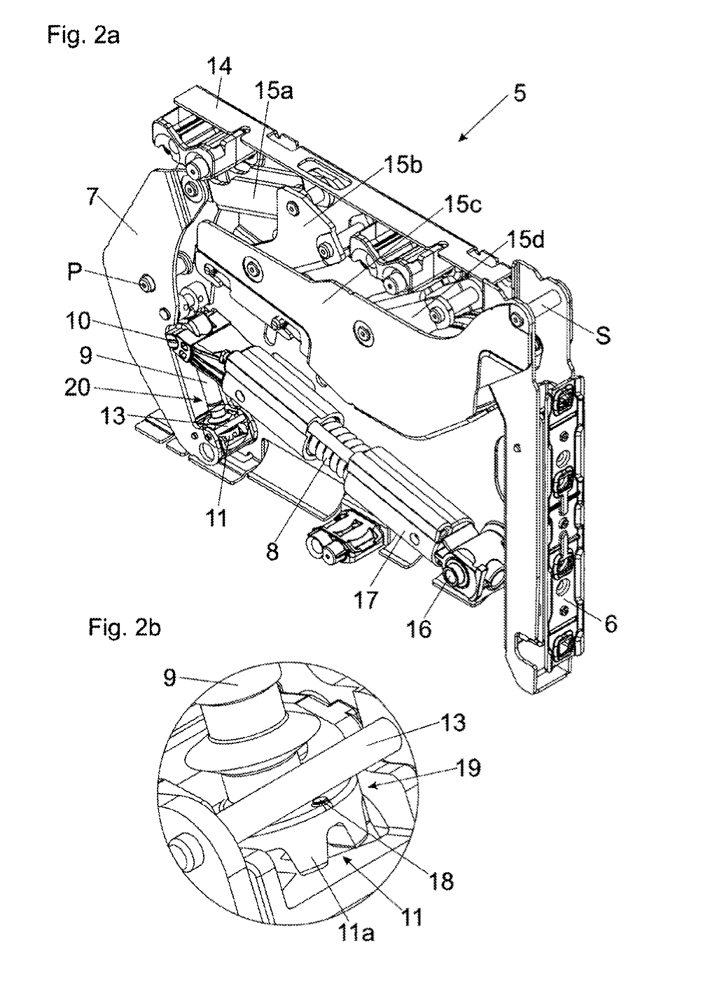

FIGS. 2a, 2b show a possible embodiment of an actuating drive as a perspective view and an enlarged detail view thereof,

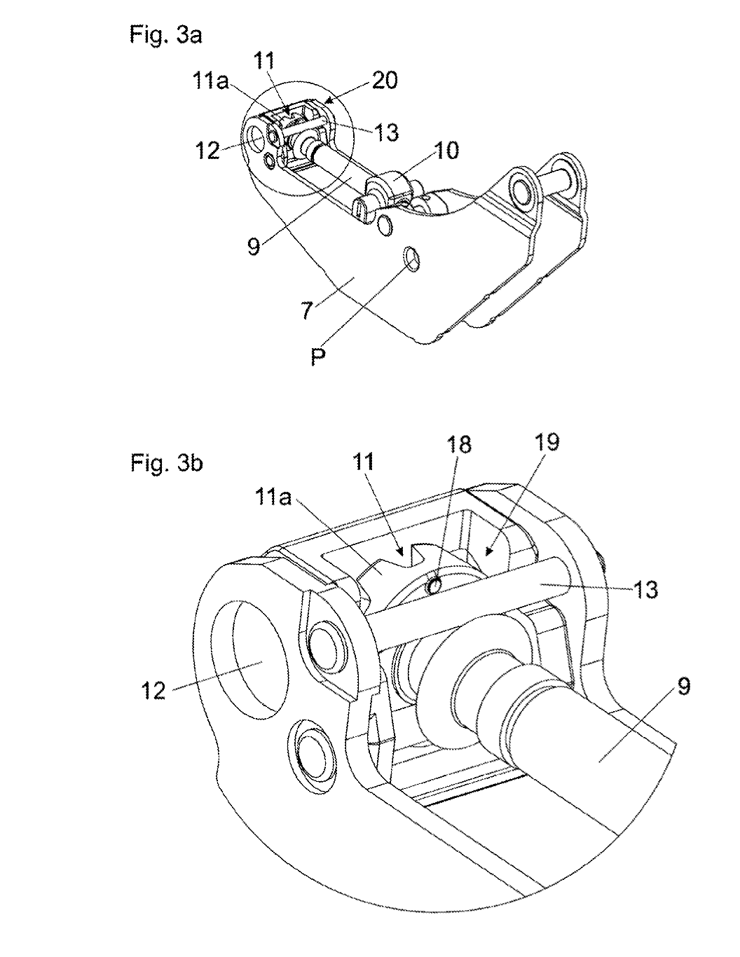

FIGS. 3a, 3b show an adjusting device mounted to an actuating lever of the actuating drive and an enlarged detail view thereof,

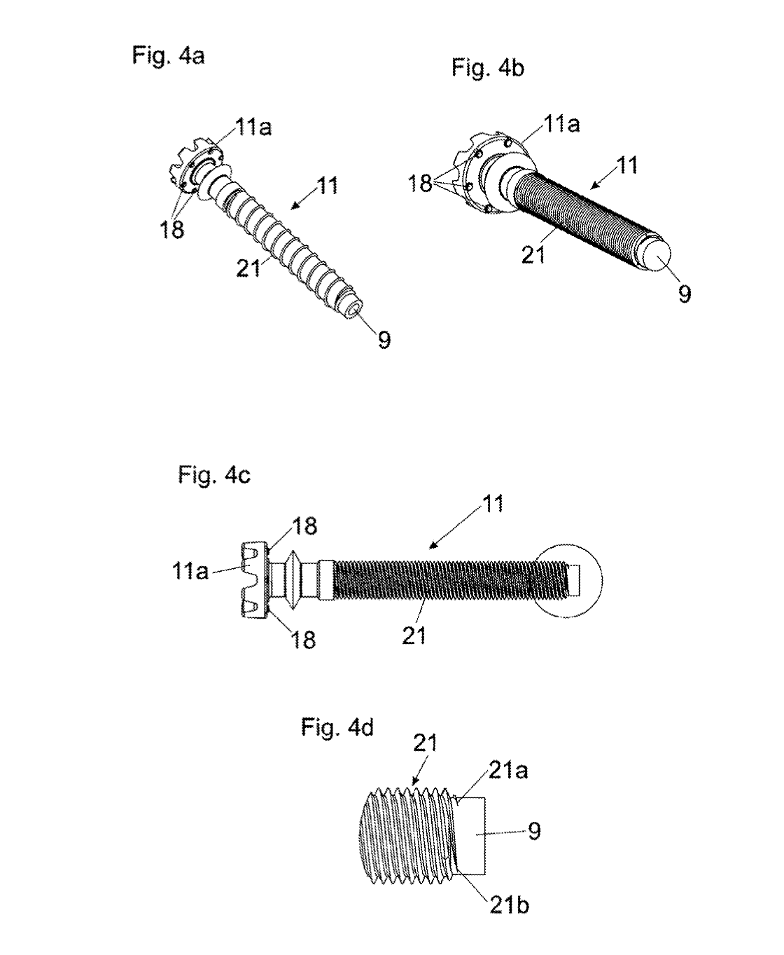

FIGS. 4a-4d show various views of two embodiments of adjusting screws, and

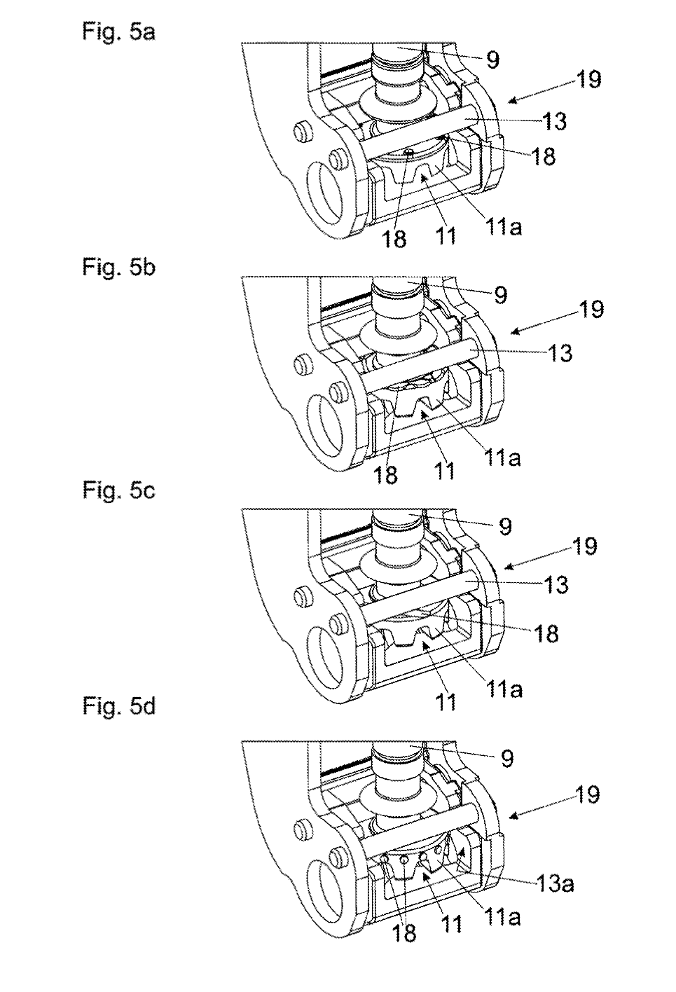

FIGS. 5a-5d show possible embodiments of a restraining device for preventing an uncontrolled rotary movement of the adjusting screw.

FIG. 1 shows a perspective view of an article of furniture 1 with a furniture carcass 2 and a flap 4 moveable upwardly relative to the furniture carcass 2. Mounted to at least one side wall 3 of the article of furniture 1 is an actuating drive 5 with a pivotally mounted actuating arm 6 for moving the flap 4. Provided for at least partially compensating for the weight of the flap 4 is a spring device 8 which acts on the actuating arm 6 with a pivotal moment in the opening direction. In the illustrated embodiment the spring device 8 firstly acts onto an actuating lever 7 which is mounted pivotably about the axis of rotation (P) and which by way of a transmission mechanism which is not shown here (for example by way of a lever mechanism and/or by way of an actuating contour-pressure roller arrangement for influencing the movements of the flap 4) pivots the actuating arm 6.

FIG. 1b shows an enlarged view of the region circled in FIG. 1a, illustrating the adjusting device 20 for adjusting the pivotal moment acting on the actuating arm 6. The spring device 8 acts on a screw nut 10 mounted displaceably along a screw shank 9 of an adjusting screw 11. The adjusting screw 11 is mounted on the actuating lever 7 rotatably but substantially axially non-displaceably. The actuating lever 7 has an opening 12, through which a screwdriver can be passed and fitted laterally to the screw head of the adjusting screw 11, wherein the longitudinal direction of a screwdriver fitted to the adjusting screw 11 and the longitudinal axis of the adjusting screw 11 include an angle of about 90°. The screw nut 10 can be moved along the screw shank 9 by displacement of the adjusting screw 11, brought about by a person, so that the position of the engagement point of the spring device 8 is variable relative to the axis of rotation (P) (FIG. 1a) of the actuating lever 7, in which case therefore the engagement point of the spring device 8 relative to the axis of rotation (P) of the actuating lever 7 is displaceable towards and away from same in the directions of the illustrated double-headed arrow. Reference 13 denotes a support means cooperating with the adjusting screw 11.

FIG. 2a shows a perspective view of a possible embodiment of an actuating drive 5. The actuating drive 5 has a housing 14, wherein the spring device 8 is supported by way of a spring holder 17 against a spring base 16 which is fixed with respect to the housing 14. The spring holder 17 is adapted to accommodate at least one (or more) spring devices 8. The spring device 8 includes at least one coil spring (in particular a compression spring) which presses against the screw nut 10. The screw nut 10 is displaceable by rotation of the adjusting screw 11 along the screw shank 9 relative to the axis of rotation (P) of the actuating lever 7. The two-armed actuating lever 7 acts as a deflection lever which transmits the force of the spring device 8 by way of the transmission levers 15a, 15b, 15c and 15d to the actuating arm 6 and pivots the actuating arm 6 about the pivoting axis (S).

FIG. 2b shows an enlarged view of the region circled in FIG. 2a. It is possible to see the adjusting screw 11 which has a screw head 11 a as well as a screw shank 9 adjoining same, with a thread. The Figure shows a restraining device 19 operative between the screw head 11a and a support means 13. In the illustrated Figure the restraining device 19 includes, preferably knob-shaped, surface elements 18 which can be arranged at the underside and/or at the peripheral edge of the screw head 11a. By virtue of the force acting due to the spring device 8, the knob-shaped surface elements 18 bear with pressure against the support means 13 which is fixed with respect to the housing 14. In the illustrated embodiment, the support means 13 is in the form of a bolt against which the knob-shaped surface elements 18 bear. The surface elements 18 prevent an uncontrolled displacement of the adjusting screw 11, as the surface elements 19 restrain a rotation of the adjusting screw 11. In the case of a controlled rotation of the adjusting screw 11 by a user, the surface elements 18 which are of a cambered configuration respectively bear against the support means 13 whereby the screw head 11 a is lifted at respective regular intervals by the height of the knob-shaped surface elements 18 relative to the support means 13 and against the force of the spring device 8 so that the adjusting screw 11 can be positioned in predetermined rotary positions. By virtue of the provided restraining device 19, the screw shank 9 can also be provided with threads which, upon actuation of the adjusting screw 11, permit rapid displacement of the screw nut 10 relative to the screw shank 9. The thread on the screw shank 9 can be for example in the form of a thread with a high pitch gradient and/or in the form of a two- or multiple thread. The use of a two- or multiple thread has the advantage that the load-bearing capacity of the seat of the screw nut 10 on the screw shank 9 is improved in comparison with a single thread with a high pitch gradient.

FIG. 3a shows a perspective view of the actuating lever 7 on which the adjusting device 20 is mounted. In the position of use, the actuating lever 7 is mounted pivotably about the axis of rotation (P). A plurality of surface elements 18 are arranged at the underside of the screw head 11a distributed in the region of the peripheral edge of the screw head 11a, for respectively bearing against the support means 13 in the form of the bolt. Upon displacement by means of a screwdriver—which is passed through the opening 12—the adjusting screw 11 can be rotated in controlled fashion, wherein, due to the cooperation of the knob-shaped surface elements 18 with the support means 13, controlled displacement is possible but in contrast uncontrolled displacement is prevented, in particular when the thread 21 on the adjusting screw 11 does not have an inherent self-locking action. FIG. 3b shows an enlarged view of the region circled in FIG. 3a.

FIG. 4a shows a perspective view of a possible embodiment of an adjusting screw 11. Arranged at the underside of the screw head 11a are a plurality of surface elements 18 respectively cooperating with a support means 13 of the actuating drive 5. The screw shank 9 is provided with a thread 21 which has a double or multiple pitch in comparison with a regular thread. In that way, upon just slight rotary movements of the adjusting screw 11 it is possible to bring about a correspondingly great adjustment stroke movement of the screw nut 10.

FIG. 4b shows an alternative embodiment of the adjusting screw 11, wherein the thread 21 is in the form of a multi-flight, preferably three-flight, thread 21. The pitch of the thread 21 in FIG. 4b can be of the same value as that of the thread 21 in FIG. 4a, but the load-bearing capability of the seat of the screw nut 10 on the screw is improved as, in comparison with FIG. 4a, a plurality of screw flights of the thread 21 are simultaneously received within the screw nut 10. Multi-flight threads 21 have a relatively great thread pitch angle and can already bring about a great axial displacement of the screw nut 10 with a partial rotation of the adjusting screw 11. If the thread 21 is of a two-flight nature, a new thread flight begins every 180°, in the case of a three-flight thread 21 a new thread flight begins every 120°. FIG. 4c shows a side view of the adjusting screw 11 of FIG. 4b, while FIG. 4d shows a view on an enlarged scale of the region circled in FIG. 4b, wherein two thread flights 21a, 21b which are displaced through 120° terminate at the end of the screw shank 9. The pitch of the thread 21 can be at least 1.6 mm, preferably at least 2.4 mm.

FIGS. 5a-5d show various embodiments of the restraining device 19 for restraining an uncontrolled rotary movement of the adjusting screw 11. In FIG. 5a, formed at the underside of the screw head 11a are knob-shaped surface elements 18 which bear against the support means 13 to inhibit an uncontrolled rotary movement of the adjusting screw 11. FIG. 5b shows a relief-like structure of the surface elements 18 which is also disposed at the underside of the screw head 11a and which cooperates with the support means 13. FIG. 5c shows a surface element 18 in the form of an elongate groove or recess portion, wherein the support means 13 in bolt form is pressed into that groove or recess portion after rotation of the adjusting screw 11 through 360°. FIG. 5d shows surface elements 18 arranged at the peripheral edge of the screw head 11a, the surface elements 18 cooperating with a lateral support means 13a as shown in FIG. 5d. The support means 13a at least portion-wise surrounds the peripheral edge of the screw head 11a and cooperates with the peripheral edge of the screw head 11a in the manner of a slipping clutch, wherein the screw head 11a slips relative to the support means 13a after a torque to be applied has been exceeded. Making the support means 13a from plastic provides that the screw head 11a is rotatable after overcoming a predetermined torque (upon controlled displacement of the adjusting screw 11 by a user).

The present invention is not limited to the illustrated embodiments but includes or extends to all variants and technical equivalents which can fall within the scope of the accompanying claims. The positional references adopted in the description such as for example up, down, lateral and so forth are also related to the directly described and illustrated Figure and are to be appropriately transferred to a new position.

1. An actuating drive for moving a flap of an article of furniture, comprising:
at least one pivotably mounted actuating arm for moving the flap,
a spring device for acting on the actuating arm with a pivotal moment in an opening direction,
an adjusting device having an adjusting screw with a thread, wherein the acting pivotal moment of the spring device on the actuating arm is adjustable by a rotary movement of the adjusting screw,
wherein the adjusting screw has a screw shank, wherein a screw nut is mounted displaceably along the screw shank by a rotary movement of the adjusting screw,
wherein the adjusting screw has a restraining device which is separate from the thread and which prevents an unintentional rotary movement of the adjusting screw.

2. The actuating drive according to claim 1, wherein the restraining device is operative between the adjusting screw and a support means of the actuating drive.

3. The actuating drive according to claim 1, wherein the restraining device has surface elements which are arranged at the adjusting screw and which cooperate with the support means of the actuating drive.

4. The actuating drive according to claim 3, wherein the surface elements are formed or arranged on a screw head, preferably at the underside and/or at a peripheral edge, of the adjusting screw.

5. The actuating drive according to claim 3, wherein the surface elements are in the form of knobs, grooves, teeth, points, raised portions, recessed portions and/or in the form of a relief-like structure.

6. The actuating drive according to claim 3, wherein the adjusting screw can be positioned in predetermined rotary positions by the surface elements.

7. The actuating drive according to claim 1, wherein the thread has two or more thread flights.

8. The actuating drive according to claim 1, wherein the spring device acts on the screw nut.

9. The actuating drive according to claim 1, wherein the adjusting screw is mounted to an actuating lever pivotable about an axis of rotation, wherein the position of the engagement point of the spring device relative to the axis of rotation of the actuating lever is displaceable within predetermined limits by a rotary movement of the adjusting screw.

10. The actuating drive according to claim 1, wherein the spring device has at least one coil spring for acting on the actuating arm.

11. An arrangement with an actuating drive according to claim 1 and with a flap of an article of furniture.

12. The arrangement according to claim 11, wherein a first end of the actuating arm is hingedly connected via a pivoting axis to a side wall of a furniture carcass and a second end of the actuating arm is connected to the flap.
